(19) United States
(12) Patent Application Publication
(10) Pub. No.: US 2009/0125840 A1
(43) Pub. Date: May 14, 2009

(54) CONTENT DISPLAY SYSTEM

(75) Inventors: John R. Squilla, Rochester, NY (US); Joseph P. Divincenzo, Rochester, NY (US)

Correspondence Address: Carestream Health, Inc., 150 Verona Street, Rochester, NY, 14608, US

(73) Assignee: Carestream Health, Inc.

(21) Appl. No.: 11/939,744

(22) Filed: Nov. 14, 2007

(51) Int. Cl. G06F 3/048

(52) U.S. Cl. 715/810

(57) ABSTRACT

A method of workflow management includes collecting heterogeneous content, associated with a surgical procedure, from a plurality of heterogeneous content sources, selecting a plurality of inputs from the heterogeneous content, and assigning each input of the plurality of inputs to at least one phase of a desired surgical sequence. A particular method also includes displaying a subset of the inputs assigned to a first phase of the surgical sequence and selecting one of the displayed inputs. Selecting one of the displayed inputs enables content-specific functionality associated with the selected one of the displayed inputs.

### FIELD OF THE INVENTION

The present invention relates to equipment used to display content related to a clinical or medical procedure, and, in particular, to equipment used to collect, organize, and display content at a clinical work site, a healthcare professional's office, and/or remote locations.

### BACKGROUND OF THE INVENTION

Many different pieces of medical equipment are utilized in healthcare environments for the display of patient information. Such medical equipment is used by surgeons and other healthcare professionals when performing various medical procedures and the efficient use of such equipment is essential to providing quality service to patients. Streamlining and/or otherwise improving the efficiency of healthcare environment operations with existing equipment, however, can be difficult for a number of reasons.

For example, typical operating rooms are often cluttered with a multitude of monitors, computers, monitoring systems, data input devices, and data storage devices. Although the content and other data provided by these different devices can be important to the success of the operation being performed, a cluttered operating room can result in inefficient workflow and poor patient service. Also, a lack of interoperability between the many disparate devices can increase the delay and inconvenience associated with the use of such devices for patient care.

Moreover, existing operating room display devices are not configured for digital customization of content according to the physician's preferences, the type or source of the content, and other factors. Nor is the digital content supplied in a manner and organized such that the physician can view the content in a desired surgical sequence. The limited functionality of existing display devices can hinder the physician during complex surgical procedures. In summary, although physicians often require nearly instantaneous access to information, in an appropriate format, and without leaving the patient's side, current operating room display devices are not configured to provide such access.

Accordingly, the disclosed system and method are directed towards overcoming one or more of the problems set forth above.

### SUMMARY OF THE INVENTION

In an exemplary embodiment of the present disclosure, a method of workflow management includes collecting heterogeneous content associated with a surgical procedure from a plurality of heterogeneous content sources, selecting a plurality of inputs from the heterogeneous content and assigning each input of the plurality of inputs to at least one phase of a desired surgical sequence. The method also includes displaying a subset of the inputs assigned to a first phase of the surgical sequence and selecting one of the displayed inputs. Selecting one of the displayed inputs enables content-specific functionality associated with the selected one of the display inputs.

In another exemplary embodiment of the present disclosure, a method of workflow management includes receiving content associated with a surgical procedure from a plurality of heterogeneous sources, selecting a plurality of inputs from the received content, associating content-specific functionality with each of the plurality of selected inputs and assigning each of the plurality of selected inputs to a phase of a desired surgical sequence. The method also includes assigning each of the plurality of selected inputs to one of a primary priority level, a secondary priority level, and a tertiary priority level. The method further includes displaying a plurality of primary priority level inputs associated with a first phase of the surgical sequence and selecting one of the displayed inputs. Selecting one of the displayed inputs causes content-specific functionality associated with the selected one of the displayed inputs to be displayed.

In still another exemplary embodiment of the present disclosure, a workflow management method includes receiving content associated with a surgical procedure, selecting a plurality of inputs from the content based on a known set of physician preferences, and assigning each input of the plurality of inputs to a phase of a desired surgical sequence. The method also includes assigning each input of the plurality of inputs to one of a plurality of priority levels based on the known set of physician preferences, displaying the inputs assigned to a first priority level of the plurality of priority levels, and displaying universal functionality associated with each of the displayed inputs. The method further includes selecting one of the displayed inputs. Selecting one of the displayed inputs enables additional functionality associated with the selected input.

In a further exemplary embodiment of the present disclosure, a modular healthcare workflow management system includes at least one of a collection component, an organization component, and a display component. The collection component is configured to request and receive healthcare content in accordance with a predefined checklist. The organization component is configured to select a plurality of inputs from the content, assign each input of the plurality of inputs to at least one phase of a surgical sequence, and assign each input of the plurality of selected inputs to a priority level within the surgical sequence. The display component is configured to display an initial set of primary priority level inputs, wherein selecting a displayed primary priority level input causes at least one content-specific functionality icon to be displayed.

### BRIEF DESCRIPTION OF THE DRAWINGS

FIG. 1 is a diagrammatic illustration of a workflow management process according to an exemplary embodiment of the present disclosure.

FIG. 2 is a diagrammatic illustration of a content display system according to an exemplary embodiment of the present disclosure.

FIG. 3 is a diagrammatic illustration of a collection phase of the exemplary workflow management process shown in FIG. 1.

FIG. 4 is a diagrammatic illustration of an organization phase of the exemplary workflow management process shown in FIG. 1.

FIG. 5 is a diagrammatic illustration of a display phase of the exemplary workflow management process shown in FIG. 1.

FIG. 6 illustrates a display device according to an exemplary embodiment of the present disclosure.

FIG. 7 illustrates a display device according to another exemplary embodiment of the present disclosure.

FIG. 8 illustrates a display device according to a further exemplary embodiment of the present disclosure.

### DETAILED DESCRIPTION OF THE INVENTION

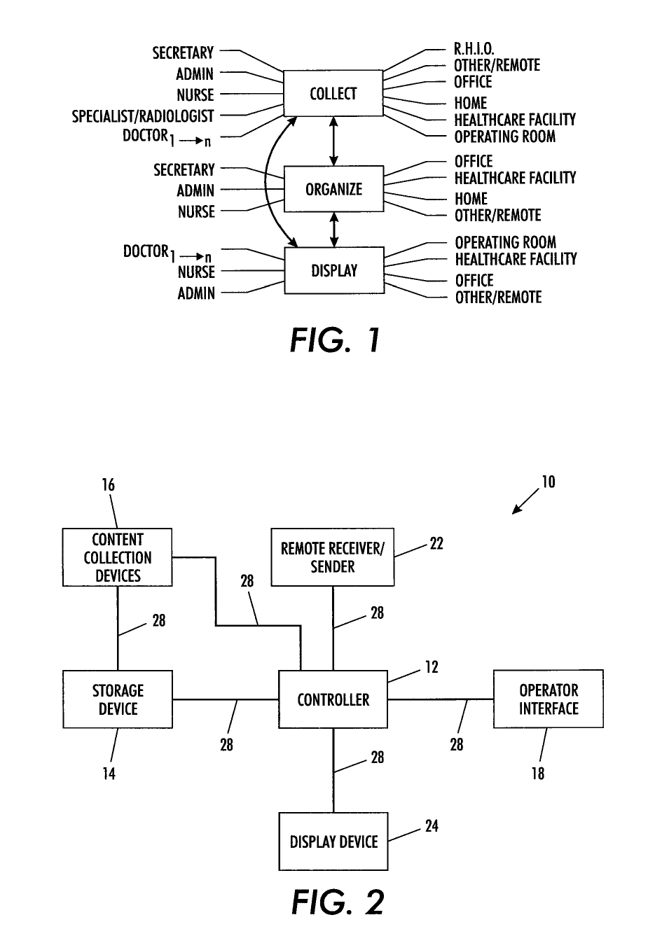

As shown in FIG. 1, a workflow management process according to an exemplary embodiment of the present comprises at least a collection phase, an organization phase, and a display phase. During the collection phase, information including but not limited to patient data, medical records, patient photos, videos, medical test results, radiology studies, X-rays, medical consultation reports, patient insurance information, CT scans, and other information related to a medical or surgical procedure to be performed (hereinafter referred to as “content”) can be collected by one or more staff members of a healthcare facility. As shown in FIG. 1, such staff members can include, but are not limited to, secretaries, administrative staff, nurses, radiologist or other specialists, and physicians.

The collected content can originate from a variety of heterogeneous sources such as, for example, different healthcare facilities, different physicians, different medical laboratories, different insurance companies, a variety of picture archiving and communication system (hereinafter referred to as “PACS”) storage devices, and/or different clinical information systems. Likewise, the collected content can be captured in a variety of heterogeneous locations such as, for example, a physician's office, the patient's home, numerous healthcare facilities, a plurality of Regional Health Information Organizations (“RHIOs”), different operating rooms, or other remote locations. As used herein, the term “RHIO” refers to a central storage and/or distribution facility or location in which hospitals and/or other healthcare facilities often share imaging and other content.

In addition, content collected within the operating room can include any kind of content capable of being captured during a surgical procedure such as, for example, live video of a procedure (such as a laparoscopic or other procedure) taken in real-time. Such content can also include X-rays, CR scans, other radiological images, medical images, photographs, and/or medical tests taken during the surgical procedure.

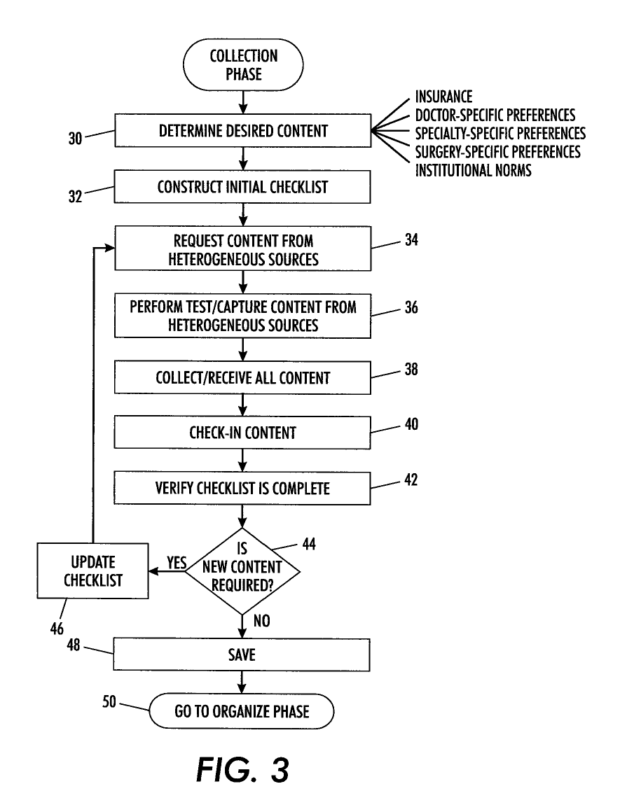

It is understood that content can also be collected during the organization and/or display phases. Such ongoing content collection is schematically represented by the double arrows connecting the organize and display boxes to the collect box in FIG. 1. Each of the heterogeneous content sources and/or locations can embed and/or otherwise associate its own distinct operating and/or viewing system with the item of content collected. For example, during the collection phase, discs containing radiological content can be received from a plurality of healthcare facilities, each configured with its own disparate (e.g., Kodak, Siemens, General Electric, etc.) tools or viewing software. The collection phase will be discussed in greater detail below with respect to FIG. 3.

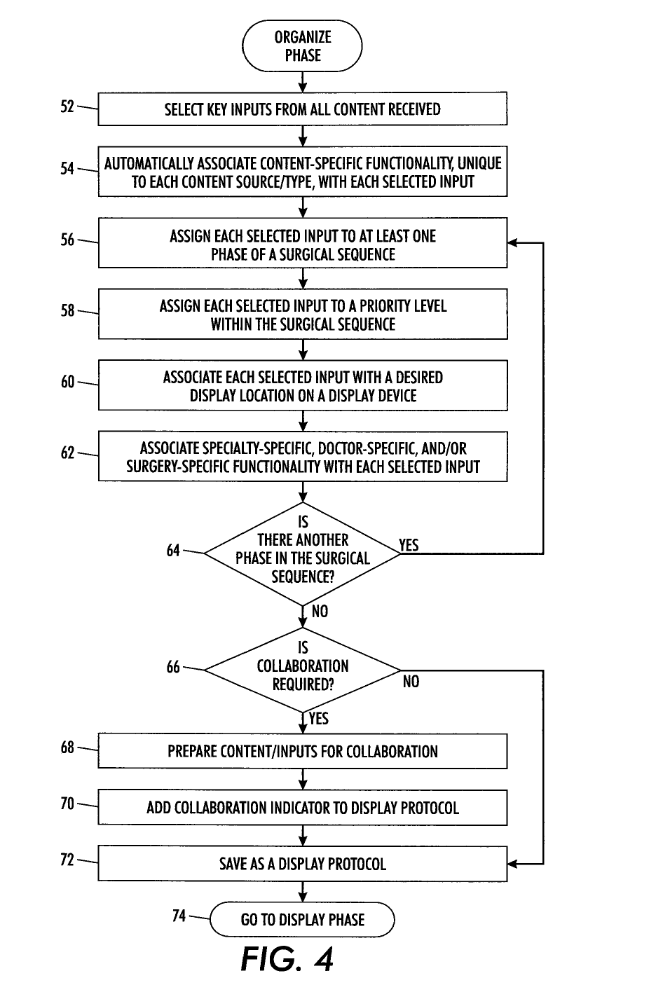

As shown in FIG. 1, during an exemplary organization phase of the present disclosure, a staff member can select key content or inputs from all of the collected content. This selection process can be governed by a variety of factors including, but not limited to, physician-specific preferences, specialty-specific preferences, surgery-specific preferences, healthcare facility norms/policies, and/or insurance company requirements. As will be discussed in greater detail below with respect to FIG. 4, the organization phase can also include, for example, associating certain functionality with each of the selected inputs, assigning each selected input to at least one phase of a surgical sequence, assigning each selected input to a priority level within the surgical sequence, and associating each selected input with a desired display location on a display device. These and other organization phase tasks can be performed at a hospital or healthcare facility, in a physician's office, at the staff member's home, the doctor's home, and/or in some other remote location.

For example, whereas known systems utilize such content from heterogeneous sources by, for example, printing each item of content and converting it into a form viewable on a patient chart, whiteboard, or light box in an operating room, the exemplary systems and methods of the present disclosure are configured to make the tools and/or viewing software associated with each item of content available for use on a digital display device. For ease of use, the disparate tools and/or viewing software, together with other content-specific, specialty-specific, physician-specific, and/or surgery-specific functionality can be associated with selected content. This functionality can be associated with each item of displayed content as the content is selected for viewing. This is different from known systems which typically utilize a functionality menu containing tools generally applicable to all of the displayed content or only a subset of the content appropriate for that tool. Such known systems can be more complicated to use than the system disclosed herein in that it can be difficult to tell which of the tools in the functionality menu can be appropriately used with a selected item of content. By only providing generalized functionality and not associating content-specific, specialty-specific, physician-specific, and/or surgery-specific functionality with the selected content, the content displayed by such known systems can have limited usefulness and can be difficult to learn to use.

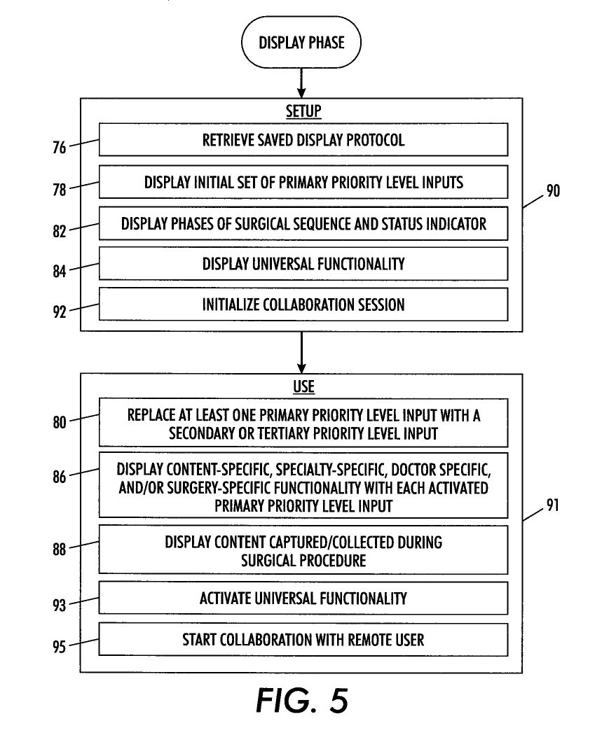

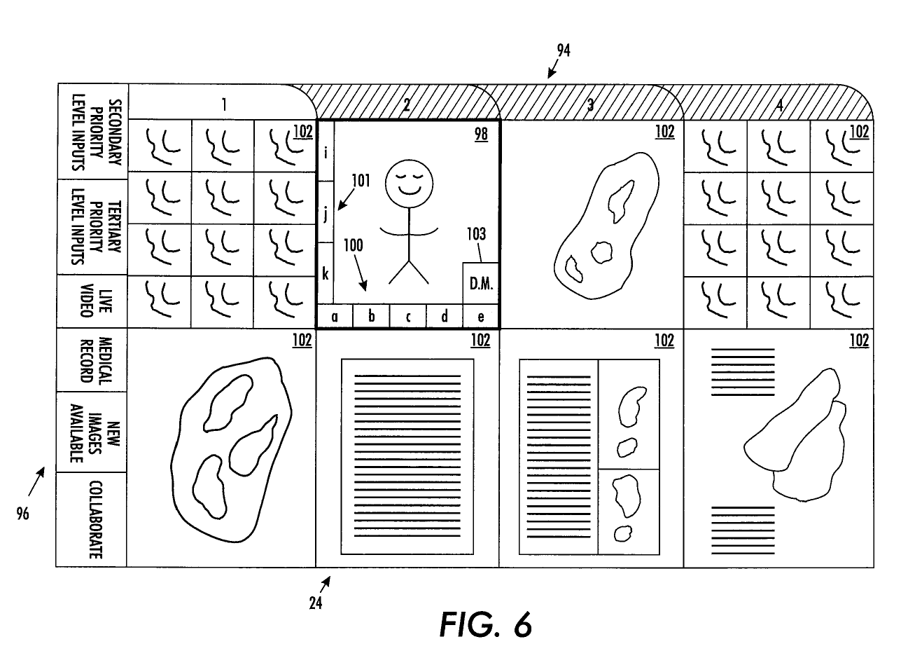

As shown in FIG. 1, during an exemplary display phase of the present disclosure, one or more doctors, nurses, or members of the administrative staff can cause the selected inputs and their associated functionality to be displayed. The content and functionality can be displayed on any conventional display device, and such exemplary devices are illustrated in FIGS. 6, 7, and 8. As will be discussed in greater detail below with respect to FIG. 5, the selected inputs and the functionality associated therewith can be displayed in a variety of locations including, but not limited to, the operating room, other rooms, offices, or locations within a hospital or healthcare facility, the physician's office, and/or other remote locations. It is understood that during the display phase, content captured by and/or collected from any department or organization within the surgeon's office, hospital, or other healthcare facility can also be displayed. As shown in FIG. 1, healthcare facility content can include, for example, a cardio angiogram or other image or series of images taken by a department within the hospital in which the content is displayed.

FIG. 2 illustrates a workflow management system 10 according to an exemplary embodiment to the present disclosure. The workflow management system 10 of the present disclosure can be modular in that the components of the system 10 can be purchased, sold, and/or otherwise used separately. In addition, the modularity of the system 10 enables the different components to be used at different locations by different users. For example, the modular workflow management system 10 of the present disclosure can include a collection component, an organization component, and a display component. Each of the separate components of the workflow management system 10 can be used in different locations by different users, as illustrated in FIG. 1. Moreover, each of the different components of the modular workflow management system 10 can be configured to perform different functions such as, for example, collection, organization, and display.

In an exemplary embodiment, a modular workflow management system 10 includes a controller 12. The controller 12 can be connected to one or more storage devices 14, one or more content collection devices 16, one or more operator interfaces 18, one or more display devices 24, and/or one or more remote receivers/senders 22 via one or more connection lines 28. It is understood that, in an additional embodiment, the controller 12 can be connected to the remote receiver/sender 22, the one or more operator interfaces 18, the one or more display devices, 24, the one or more storage devices 14 and/or the one or more content collection devices 16 via satellite, telephone, internet, intranet, or wireless means. In such an exemplary embodiment, one or more of the connection lines 28 can be omitted.

The controller 12 can be any type of controller known in the art configured to assist in manipulating and/or otherwise controlling a group of electrical and/or electromechanical devices or components. For example, the controller 12 can include an Electronic Control Unit (“ECU”), a computer, a laptop, and/or any other electrical control device known in the art. The controller 12 can be configured to receive input from and/or direct output to one or more of the operator interfaces 18, and the operator interfaces 18 can comprise, for example, a monitor, a keyboard, a mouse, a touch screen, and/or other devices useful in entering, reading, storing, and/or extracting data from the devices to which the controller 12 is connected. As will be described in greater detail below, the operator interfaces 18 can further comprise one or more hands-free devices. The controller 12 can be configured to execute one or more control algorithms and/or control the devices to which it is connected based on one or more preset programs. The controller 12 can also be configured to store and/or collect content regarding one or more healthcare patients and/or one or more surgical or healthcare procedures in an internal memory.

In an exemplary embodiment, the controller 12 can also be connected to the storage device 14 on which content and/or other patient data is retrievably stored. The storage device 14 can be, for example, an intranet server, an internal or external hard drive, a removable memory device, a compact disc, a DVD, a floppy disc, and/or any other known memory device. The storage device 14 may be configured to store any of the content discussed above. In an embodiment in which the controller 12 comprises an internal memory or storage device, the storage device 14 can supplement the capacity of the controller's internal memory or, alternatively, the storage device 14 can be omitted. In an embodiment where the storage device 14 has been omitted, the content collection devices 16 can be connected directly to the controller 12. In another exemplary embodiment, the storage device 14 can comprise a local server, and a display protocol comprising the content discussed above and the functionality associated with selected inputs can be saved to the server. In still another exemplary embodiment, the storage device 14 can comprise a DVD and the display protocol can be saved to the DVD. In such an embodiment, the display protocol can be fully activated and/or otherwise accessed without connecting the controller 12 to a server.

The connection lines 28 can be any connection means known in the art configured to connect and/or otherwise assist the controller 12 in transmitting data and/or otherwise communicating with the components of the workflow management system 10. In an exemplary embodiment, the connection lines 28 can be conventional electrical wires. In an alternative exemplary embodiment, the connection lines 28 can be omitted and as discussed above, the controller 12 can be connected to one or more components of the workflow management system 10 via wireless connection means such as, for example, Bluetooth or wireless internet standards and protocols.

The content collection devices 16 can be any device known in the art capable of capturing and/or collecting images, data, and/or other medical content. The content captured and/or collected by the content collection devices 16 can be historical content and/or real-time content. Accordingly, the content collection devices 16 can include capture devices and/or systems such as, for example, ultrasound systems, endoscopy systems, computed tomography systems, magnetic resonance imaging systems, x-ray systems, and vital sign monitoring systems or components thereof. The content collection devices 16 can also include systems or devices configured to retrievably store and/or archive captured content such as, for example, medical records, lab testing systems, videos, still images, PACS systems, clinical information systems, film, paper, and other image or record storage media. Such content collection devices 16 can store and/or otherwise retain content pertaining to the patient that is receiving healthcare. This stored content can be transferred from the content collection devices 16 to the storage device 14 and/or the controller 12 during the collection phase discussed above with respect to FIG. 1.

The content collection devices 16 can also capture, collect, and/or retain content pertaining to the surgical procedure that is to be performed on the patient and/or historical data related to past surgical procedures performed on other patients. The content collection devices 16 can store such content in any form such as, for example, written form, electronic form, digital form, audio, video, and/or any other content storage form or format known in the art.

The content collection devices 16 can be used during, for example, inpatient or outpatient surgical procedures, and the content collection devices 16 can produce two or three dimensional “live” or “substantially live” content. It is understood that substantially live content can include content or other data recently acquired, but need not be up-to-the-second content. For example, the content collection devices 16 can capture content a period of time before providing substantially live content to the storage device 14 and/or the controller 12. Delays can be expected due to various factors including content processing bottle necks and/or network traffic. Alternatively, the content collection devices 16 can also include imaging devices that function in a manner similar to, for example, a digital camera or a digital camcorder. In such an exemplary embodiment, the content collection devices 16 can locally store still images and/or videos and can be configured to later upload the substantially live content to the storage device 14 and/or the controller 12. Thus, it is understood that substantially live content can encompass a wide variety of content including content acquired a period of time before uploading to the controller 12. In an exemplary embodiment, the real-time and historical content discussed above can be in a DICOM compliant format. In an additional exemplary embodiment, the real-time and/or historical content can be in a non-DICOM compliant format.

Healthcare professionals are often separated by large distances and can, in some circumstances, be located around the world. Moreover, collaboration between healthcare professionals is often difficult to coordinate due to scheduling conflicts. Accordingly, the remote receiver/sender 22 can be, for example, any display workstation or other device configured to communicate with, for example, a remote server, remote workstation, and/or controller. The remote receiver/sender 22 can be, for example, a computer, an ECU, a laptop, and/or other conventional workstation configured to communicate with, for example, another computer or network located remotely. Alternatively, in an exemplary embodiment, the functions performed, controlled, and/or otherwise executed by the controller 12 and the remote receiver/sender 22 can be performed by the same piece of hardware. The remote receiver/sender 22 can be connected to the controller 12 via satellite, telephone, internet, or intranet. Alternatively, the remote receiver/sender 22 can be connected to a satellite, telephone, the internet, an intranet, or, the controller 12, via a wireless connection. In such an exemplary embodiment, the connection line 28 connecting the remote receiver/sender 22 to the controller 12 can be omitted.

The remote receiver/sender 22 can receive content or other inputs sent from the controller 12 and can be configured to display the received content for use by one or more healthcare professionals remotely. For example, the remote receiver/sender 22 can receive content representative of a computed tomography image, a computed radiography image, and/or x-rays of a patient at the surgical worksite in which the controller 12 is located. A radiologist or other healthcare professional can then examine the content remotely for any objects of interest using the remote receiver/sender 22. In such an exemplary embodiment, the remote receiver/sender 22 is configured to enable collaboration between a remote user and a physician located in, for example, an operating room of a healthcare facility. The remote receiver/sender 22 can also include one or more of the operator interfaces 18 discussed above (not shown). The remote healthcare professional can utilize the operator interfaces of the remote receiver/sender 22 to send content to and receive content from the controller 12, and/or otherwise collaborate with a physician located in the healthcare facility where the workflow management system 10 is being used.

The display device 24 can be any display monitor or content display device known in the art such as, for example, a cathode ray tube, a digital monitor, a flat-screen high-definition television, a stereo 3D viewer, and/or other display device. The display device 24 can be capable of displaying historical content and/or substantially real-time content sent from the controller 12. In an exemplary embodiment, the display device 24 can be configured to display a plurality of historical and/or real-time content on a single screen or on a plurality of screens. In addition, the display device 24 can be configured to display substantially real-time content and/or historical content received from the remote receiver/sender 22. Display devices 24 according to exemplary embodiments of the present disclosure are diagrammatically illustrated in FIGS. 6, 7, and 8.

The display device 24 can also display icons and/or other images indicative of content-specific and/or other functionality associated with the displayed content. For example, a user can select one of a plurality of displayed content, and selecting the content may cause icons representative of content-specific, specialty-specific, physician-specific, and/or surgery-specific functionality associated with the selected content to be displayed on the display device 24. Selecting a functionality icon can activate the corresponding functionality and the activated functionality can be used to modify and/or otherwise manipulate the selected content. Such functionality will be discussed with greater detail below and any of the operator interfaces 18 discussed above can be configured to assist the user in, for example, selecting one or more of the displayed content, selecting a functionality icon to activate functionality, and/or otherwise manipulating or modifying the displayed content.

In healthcare environments such as, for example, operating rooms or other surgical worksites, healthcare professionals may desire not to touch certain instruments for fear of contaminating them with, for example, blood or other bodily fluids of the patient. Accordingly, in an exemplary embodiment, the operator interfaces 18 discussed above can include one or more hands-free devices configured to assist in content selection and/or manipulation of content without transmitting bacteria or other contaminants to any components of the workflow management system 10. Such devices can include, for example, eye-gaze detection and tracking devices, virtual reality goggles, light wands, voice-command devices, gesture recognition device and/or other known hands-free devices. Alternatively, wireless mice, gyroscopic mice, accelerometer-based mice, and/or other devices could be disposed in a sterile bag or other container configured for use in a sterile surgical environment.

Although not shown in FIG. 2, such operator interfaces 18 can be used by multiple users and can be connected directly to the display device 24 via one or more connection lines 28. Alternatively, the operator interfaces 18 can be wirelessly connected to the display device 24. In still another exemplary embodiment of the present disclosure, the operator interfaces 18 can be connected directly to the controller 12 via one or more connection lines 28 or via wireless means. The operator interfaces 18 discussed above can also be configured to assist one or more users of the workflow management system 10 in transmitting content between the controller 12 and one or more remote receivers/senders 22. In an exemplary embodiment in which a plurality of operator interfaces 18 are used by multiple users, a control hierarchy can be defined and associated with the plurality of operator interfaces 18 utilized.

The workflow management system 10 of the present disclosure can be used with a variety of other medical equipment in a healthcare environment such as a hospital or clinic. In particular, the workflow management system 10 can be used to streamline workflow associated with surgery or other operating room procedures. Ultimately, utilizing the content display system in a healthcare environment will require fewer machines and other medical equipment in the operating room and will result in improved efficiency. In addition, the workflow management system 10 can be more user-friendly and easier to use than existing content display systems. As will be described below, the workflow management system 10 can be used as a workflow management system configured to streamline the collection, organization, and display of content in a healthcare environment.

FIG. 3 illustrates a collection phase of a workflow management method according to an exemplary embodiment of the present disclosure. In such an exemplary embodiment, the user of the workflow management system 10 can determine the content necessary and/or desired for the surgical procedure to be accomplished (Step 30). This determination may be based on a number of factors including, but not limited to, physician-specific preferences, specialty-specific preferences, surgery-specific preferences, the institutional or healthcare facility norms or rules, and insurance company requirements. Once the scope of the desired content has been determined, a staff member can construct an initial checklist (Step 32) stating substantially all of the content the physician would like to have available during the surgical procedure. The initial checklist can include a plurality of heterogeneous content originating from a plurality of heterogeneous sources. Such content and content sources can include any of the heterogeneous content and sources discussed above with respect to FIG. 2. This checklist may be saved for re-use in similar future cases. Alternatively, the checklist can be dynamically reconstructed when necessary for future cases. The user can then request the content on the checklist from the plurality of heterogeneous sources (Step 34) in an effort to complete the checklist. For example, over the years, several radiological studies may have been performed on a subject patient in a variety of different healthcare facilities across the country. The initial checklist may list each of the radiological studies and, in Step 34, a staff member may request these studies from each of the different healthcare facilities in accordance with the preference of the physician. Alternatively, the checklist may contain requests for previous radiology studies that may be relevant for the intended procedure from healthcare facilities or healthcare professionals that have previously treated the patient. Such requests can also include a broadcast request to multiple RHIOs.

Preparing for an upcoming surgical procedure can also require performing one or more tests and/or otherwise capturing content identified on the checklist from a plurality of heterogeneous sources (Step 36). Content listed on the checklist may not have been collected from the subject patient in any prior examinations and must, therefore, be collected by either the staff of the healthcare facility in which the patient is currently visiting or by a different healthcare facility. For example, if a healthcare facility located remotely has a particular specialty, the administrative staff or physician may request that the subject patient visit the alternate healthcare facility to have a test performed and/or additional content captured. Requesting content from heterogeneous sources in Step 34 may also cause the administrative staff to collect and/or otherwise receive any and all of the content listed on the initial checklist (Step 38) and, once received or otherwise collected, the content can be checked in or otherwise marked as collected on the checklist (Step 40).

Once substantially all of the heterogeneous content has been collected, the administrative staff can verify that the initial checklist is complete (Step 42), and if the checklist is not complete, or if any new or additional content is required (Step 44), the administrative staff can update the initial checklist (Step 46) with the additional content. If the initial checklist requires an update, the administrative staff can request the additional content from any of the sources discussed above (Step 34). As discussed above, upon requesting this additional content, the staff can either perform tests or otherwise capture content from the subject patient or can collect content that has been captured from alternative heterogeneous sources (Step 36). The staff may then perform Steps 38-42 as outlined above until the revised checklist is complete. Accordingly, if no new content is required, and the checklist is thus complete, the staff can save all of the collected content (Step 48) and pass to the organization phase of the exemplary workflow management process disclosed herein (Step 50). Although Step 50 is illustrated at an end of a collection phase, it is understood that the user can save content at any time during the collection, organization and display phases described herein. In addition, the collection phase illustrated can also include the step of releasing captured and/or collected content to healthcare facilities or other organizations prior to the completion of the initial checklist (not shown).

FIG. 4 illustrates an exemplary organization phase of the present disclosure. As shown in FIG. 4, once all of the content is received in the collection phase, the administrative staff can select each of the key inputs to be used or otherwise displayed from all of the received content (Step 52). It is understood that the key inputs selected can correspond to the items of collected content likely to be utilized by the physician during the upcoming surgical procedure. These key inputs may be selected according to, for example, the specific preferences of the physician, the various factors critical to the surgery being performed, and/or any specialty-specific preferences identified by the physician. Upon selection of the key inputs, the controller 12 and other components of the workflow management system 10 may automatically associate content-specific functionality unique to each content source and/or content type with each of the selected key inputs (Step 54). It is understood that, as discussed above, content-specific functionality can be functionality that is associated particularly with the type of content or the source of that content. For example, wherein the selected content is a relatively high resolution image, the content-specific functionality associated with that image may include one or more zoom and/or pan functions. This is because the source of the high resolution image may be a sophisticated imaging device configured to produce output capable of advanced modification. On the other hand, wherein the selected key content is a sequence of relatively low resolution image, such as, for example, a CT scan with 512×512 resolution per slice image, no zoom function may be associated with the content since the source of the low resolution image may not be capable of producing output which supports high-level image manipulation. With such low resolution images, however, a “cine” mode and/or 3D stereo display rendering and functionality may be made available for use if appropriate. Thus the content-specific functionality associated with the selected input in Step 54 may be a function of what the content will support by way of spatial, time manipulation, image processing preferences, display protocols, and other preferences.

The administrative staff may assign each of the selected inputs to at least one phase of a surgical sequence (Step 56). The surgical sequence may be a desired sequence of surgical steps to be performed by the physician and may be a chronological outline of the surgery. In an exemplary embodiment, the surgical sequence may comprise a number of phases, and the phases may include an accessing phase, an operative phase, an evaluation phase, and a withdraw phase. In such an exemplary embodiment, the key inputs related to accessing an area of the patient's anatomy to be operated on, while avoiding collateral damage to surrounding tissue, organs, and/or other anatomical structures, may be assigned to at least the accessing phase, key inputs related to performing an operative step once the anatomy has been accessed may be assigned to at least the operative phase, key inputs related to evaluating the area of anatomy operated upon may be assigned to at least the evaluation phase, and key inputs related to withdrawing from the area of the patient's anatomy and closing any incisions may be assigned to at least the withdrawal phase of the surgical sequence. It is understood that any of the key inputs can be assigned to more than one phase of the surgical sequence and that the surgical sequence organized in Step 56 can include fewer phases or phases in addition to those listed above depending on, for example, the physician's preferences, and the type and complexity of the surgery being performed.

In Step 58, each of the key inputs can be assigned to a priority level within the desired surgical sequence. The priority levels may include a primary priority level, a secondary priority level, and a tertiary priority level, and any number of additional priority levels can also be utilized as desired by the physician. The selected input assigned to the primary priority level can be the inputs desired by the physician to be displayed on the display device 24 as a default. For example, when the workflow management system 10 is initialized, each of the primary priority level inputs associated with a first phase of the surgical sequence can be displayed on the display device 24.

By selecting one of the displayed primary priority level inputs, the physician can be given the option of displaying at least one of the corresponding secondary or tertiary priority level inputs associated with the selected primary priority level input. Upon selecting, for example, a corresponding secondary priority level input, the primary priority level input will be replaced by the secondary priority level input and the second priority level input will, thus, be displayed in place of the previously displayed primary priority level input. In an additional exemplary embodiment, the physician can select a secondary or tertiary priority level input first, and drag the selected input over a primary priority level input to be replaced. In such an embodiment, the replaced primary priority level input will be reclassified as and/or otherwise relocated to the secondary priority level where it can be easily retrieved if needed again.

It is understood that the physician can switch between any of the primary, secondary, or tertiary priority level inputs displayed as part of the surgical sequence. It is also understood that a plurality of primary priority level inputs associated with a second phase of the surgical sequence can be displayed while at least one of the inputs associated with the first phase of the surgical sequence is being displayed. In such an exemplary embodiment, it is also understood that the second phase of the surgical sequence can be later in time than the first phase of the surgical sequence. For example, as described above, the surgical sequence can include an accessing phase, an operative phase, an evaluation phase, and a withdrawal phase, and the withdrawal phase may be later in time than the evaluation phase, the evaluation phase may be later in time than the operative phase, and the operative phase may be later in time than the accessing phase. In each of the disclosed embodiments, the layout of the surgical sequence can be modified entirely in accordance the physician's preferences.

The heterogeneous content assigned to the tertiary priority level comprises heterogeneous content that is associated with the selected inputs of at least the primary and secondary priority levels, and the primary, secondary, and tertiary priority levels are organized based upon the known set of physician preferences and/or other factors discussed above. By designating a portion of a study, medical record, or other item of content as a primary priority level or secondary level input, the entire study, medical record, or content item can be automatically selected as a tertiary priority level input. The tertiary priority level inputs can also comprise complete studies, records, or other content unrelated to the selected key inputs but that is still required due to the known set of physician preferences.

Each of the selected inputs can also be associated with a desired display location on the display device 24 (Step 60). It is understood that the step of associating each of the selected inputs with a desired display location (Step 60) can be done prior to and/or in conjunction with assigning each of the selected inputs to at least one of the priority levels discussed above with respect to Step 58. As shown in FIGS. 6, 7, and 8, the display device 24 can illustrate any number of selected inputs 98, 102 desired by the physician.

With continued reference to FIG. 4, specialty-specific, physician-specific, and/or surgery-specific functionality can also be associated with each selected input (Step 62). It is understood that the functionality discussed with respect to Step 62 may be the same and/or different than the content-specific functionality discussed above with respect to Step 54. For example, a zoom function may be associated with a relatively high resolution image, and such functionality may be content-specific functionality with regard to Step 54. However, while a surgical procedure is being performed, the physician may prefer or require one or more linear measurements to be taken on the high resolution image. Accordingly, at Step 62, linear measurement functionality that is physician-specific and/or specialty-specific can be associated with the selected high resolution image. Other such functionality can include, for example, Cobb angle measurement tools, photograph subtraction tools, spine alignment tools, and/or other known digital functionality.

Once Steps 56 through 62 have been completed for each of the selected key inputs in a phase of a surgical sequence, the administrative staff may indicate, according to the known physician preferences, whether or not an additional phase in the surgical sequence is required (Step 64). If another phase in the surgical sequence is required, Steps 56 through 62 can be repeated until no additional phases are required. The administrative staff can also determine whether or not collaboration with a remote user is required (Step 66). If collaboration is required, the workflow management system 10 and/or the staff can prepare the content and/or select inputs for the collaboration (Step 68) and, as a result of this preparation, a collaboration indicator can be added to the desired display protocol (Step 70). Once the content has been prepared and the collaboration indicator has been configured, the entire surgical sequence and associated functionality can be saved as a display protocol (Step 72). Alternatively, if no collaboration is required, none of the content will be prepared for collaboration and the surgical sequence and associated functionality can be saved as a display protocol without collaboration (Step 72). Once the display protocol has been saved, the user may proceed to the display phase (Step 74).

As shown in FIG. 5, during the display phase, the user and/or the various components of the workflow management system 10 can perform one or more setup functions (Step 90). In an exemplary embodiment, this setup step (Step 90) can include at least the Steps 76, 78, 82, 84, and 92 discussed below. For example, during setup (Step 90), the user can retrieve the saved display protocol (Step 76), and once the workflow management system 10 has been activated or initialized, an initial set of primary priority level inputs for the initial surgical phase can be displayed by the display device 24 (Step 78).

The display device 24 can also display surgical sequence phase indicators 94 representing each phase of the surgical sequence and can further display one or more status indicators representing which phase in the surgical sequence is currently being displayed (Step 82). As shown in FIGS. 6, 7, and 8, the surgical sequence phase indicators 94 can be illustrated as one or more folders or tabs (labeled as numerals 1, 2, 3, and 4) outlined in a substantially chronological manner from earliest in time to latest in time. In another exemplary embodiment, the surgical sequence phase indicators 94 can be labeled with user-defined names such as, for example, operation stage names (i.e., “accessing,” “operative,” “evaluation,” and “withdrawal”) or any other applicable sequence nomenclature. It is understood that, in still another exemplary embodiment, the surgical sequence phase indicators 94 can be labeled with and/or otherwise comprise content organization categories. Such categories may link desired content to different stages of the surgery and may be labeled with any applicable name such as, for example, “patient list,” “pre-surgical patient information,” “primary surgical information,” “secondary surgical information,” and “exit.” Accordingly, it is understood that the workflow management system 10 described herein can be configured to display content in any desirable way based on the preferences of the user.

The status indicators referred to above may be, for example, shading or other color-coded indicators applied to the surgical sequence phase indicator 94 to indicate the currently active phase of the surgical sequence. The user may toggle between any of the phases of the surgical sequence by activating and/or otherwise selecting the desired surgical sequence phase indicator 94.

As will be discussed below with respect to Step 86, the display device 24 can display a plurality of content-specific, specialty-specific physician-specific, and/or surgery-specific functionality icons 100 once a particular content 98 has been activated and/or otherwise selected for display. The display device 24 can also display a plurality of universal functionality icons 96 (Step 84) representing functionality applicable to any of the selected or otherwise displayed content regardless of content type or the heterogeneous source of the content. The universal functionality icons 96 may comprise, for example, tools configured to enable collaboration, access images that are captured during a surgical procedure, and/or display complete sections of the medical record.

It is also understood that, as shown in FIGS. 6, 7, and 8, where a collaboration indicator is displayed among the universal functionality icons 96, the user may initialize a collaboration session (Step 92) by selecting or otherwise activating the collaboration indicator. By selecting the collaboration indicator, the user may effectively login to the collaboration session. Such a login can be similar to logging in to, for example, Instant Messenger, Net Meeting, VOIP, Telemedicine, and/or other existing communication or collaboration technologies. It is understood that initializing a collaboration session in Step 92 can also include, for example, determining whether a network connection is accessible and connecting to an available network.

As shown in FIG. 5, during the display phase, the user and/or the various components of the workflow management system 10 can also perform one or more use functions (Step 91). In an exemplary embodiment, this use step (Step 91) can include at least the Steps 80, 86, 88, 93, and 95 discussed below. For example, during use (Step 91), selecting one of the displayed primary priority level inputs gives the user access to corresponding secondary and tertiary priority level inputs associated with the selected primary priority level input. By selecting one of the corresponding secondary and tertiary priority level inputs, the user can replace the primary priority level input with the secondary or tertiary priority level input (Step 80). It is understood that one or more of the universal functionality icons 96 discussed above with respect to Step 84 may assist in replacing at least one primary priority level input with a secondary or a tertiary priority level input (Step 80). It is further understood that, in an exemplary embodiment, a primary priority level input that is replaced by a secondary or tertiary level input may always be re-classified as a secondary priority level input, and may not be re-classified as a tertiary priority level input. In such an exemplary embodiment, in the event that new content is received for display, or when a primary priority level input is replaced by a tertiary priority level input, the replaced primary priority level input may be reclassified as a secondary priority level input in Step 80.

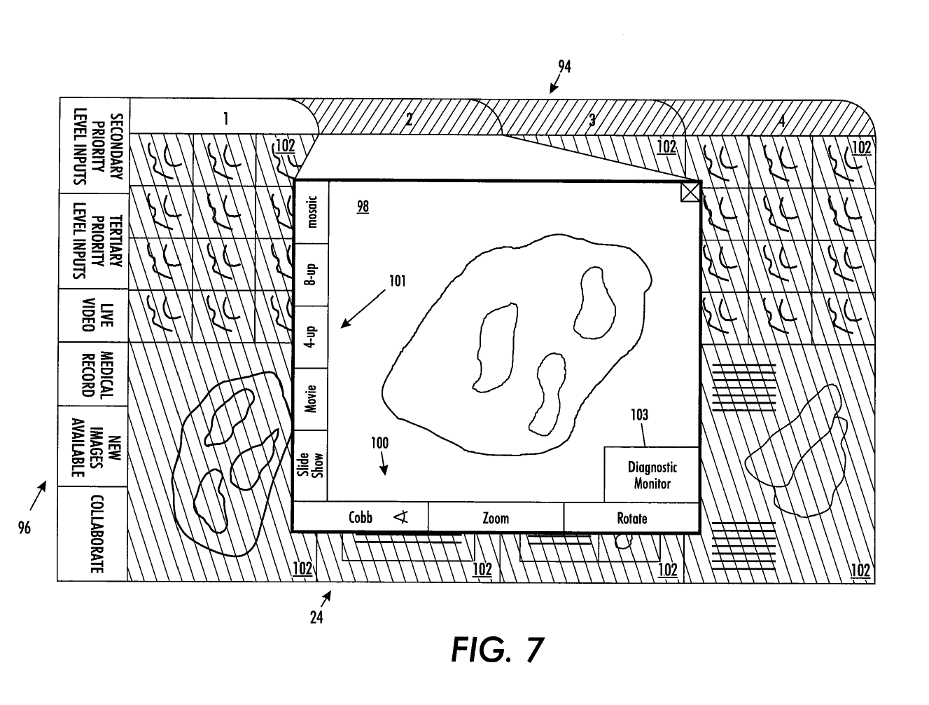

As is also illustrated in FIGS. 6, 7, and 8, the display device 24 can display content-specific, specialty-specific, physician-specific, and/or surgery-specific functionality associated with each activated primary priority level input (Step 86). For example, as illustrated in FIG. 6, in an exemplary embodiment, selecting the content 98 from the plurality of displayed content may cause functionality icons 100 representing the functionality associated with the content 98 to be displayed. In such an exemplary embodiment, functionality icons representing specific functionality associated with content 102 that is displayed, but not selected, may not be displayed. Such functionality icons may not be displayed until the content 102 is selected by the user. This is also illustrated in FIG. 7, wherein the selected input 98 is illustrated in an enlarged view and the functionality icons 100 associated with the content 98 are displayed prominently. The functionality icons 100 can include, for example, icons representing Cobb angle, zoom, rotate, and/or other functionality specifically associated with the activated primary priority level input. The icons 100 can also include, for example, a diagnostic monitor icon 103 configured to send the activated primary priority level input to a secondary diagnostic monitor for display. Such diagnostic monitors can be, for example, high-resolution monitors similar in configuration to the display device 24.

As is also shown in FIGS. 6, 7, and 8, the universal functionality icons 96 applicable to any of the contents 98, 102 displayed by the display device 24 are present at all times. Any of these universal functionality icons 96 can be activated (Step 93) during use.

In an additional exemplary embodiment, selecting the content 98 from the plurality of displayed content may cause functionality icons 101 representing display formatting associated with the content 98 to be displayed. Such display formatting may relate to the different ways in which the selected content can be displayed by the display device 24. As shown in FIG. 7, the display device 24 may be configured to display a selected content 98 in a plurality of formats including, for example, a slide show, a movie, a 4-up display, an 8-up display, a mosaic, and any other display format known in the art. The user may toggle through these different display formats, thereby changing the way in which the manner in which the selected content 98 is displayed, by selecting and/or otherwise activating one or more of the functionality icons 101.

Although not specifically illustrated in FIGS. 6, 7, and 8, it is understood that content can be captured during the collection phase, the organization phase, and/or the display phase, and any of the content captured or collected during either of these three phases can be displayed in substantially real time by the display device 24 (Step 88). Such content can be displayed by, for example, selecting the “more images available” universal functionality icon 96 (FIG. 6).

Moreover, in an exemplary embodiment, initializing the collaboration session in Step 92 may not start collaboration or communication between the user and a remote user. Instead, in such an embodiment, collaboration can be started at a later time such as, for example, during the surgical procedure. Collaboration with a remote user can be started (Step 95) by activating or otherwise selecting, for example, a “collaborate” icon displayed among the universal functionality icons 96, and the collaboration functionality employed by the workflow management system 10 may enable the user to transmit content to, request content from, and/or receive content from a remote receiver/sender once collaboration has been started.

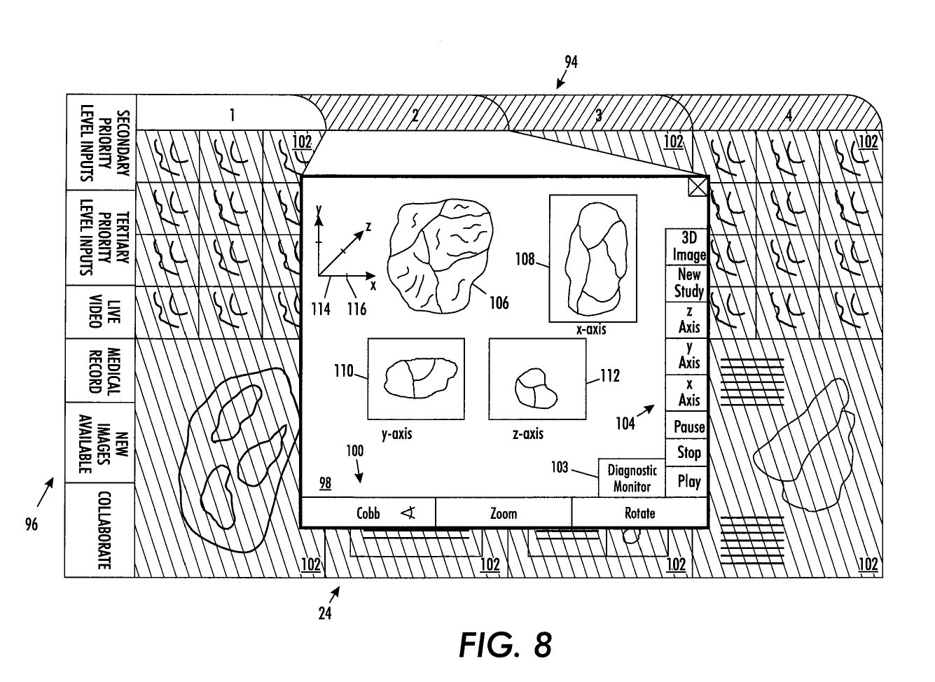

In an additional exemplary embodiment, the display device 24 can be configured to display content comprising two or more studies at the same time and in the same pane. For example, as shown in FIG. 8, the selected content 98 can comprise an image 106 that is either two or three dimensional. The image can be, for example, a three-dimensional rendering of an anatomical structure such as, a lesion, tumor, growth, lung, heart, and/or any other structure associated with a surgical procedure for which the workflow management system 10 is being used. The content 98 can further comprise studies 108, 110, 112 done on the anatomical structure. In an exemplary embodiment, the studies 108, 110, 112 can comprise two-dimensional slices/images of the anatomical structure taken in different planes. For example, as shown in FIG. 8, study 108 can be a study comprising a series of consecutive two-dimensional images of the structure wherein the images represent cross-sectional views of the structure in a plane perpendicular to the x-axis in 3D space. Likewise, study 110 can be a study comprising a series of consecutive two-dimensional images of the structure wherein the images represent cross-sectional views of the structure in a plane perpendicular to the y-axis in 3D space, and study 112 can be a study comprising a series of consecutive two-dimensional images of the structure wherein the images represent cross-sectional views of the structure in a plane perpendicular to the z-axis in 3D space. It is understood that the planes represented in the studies 108, 110, 112 can be, for example, the axial, coronal, and saggital planes, and/or any other planes known in the art. In an additional exemplary embodiment, the planes' orientation may be arbitrarily adjusted to provide alignment and viewing perspectives desired by the surgeon. For example, the surgeon may chose to align the y-axis with the axis of a major artery.

To assist the user in viewing these separate studies 108, 110, 112 at the same time, an axis 114 and a location indicator 116 can be displayed with the selected content 98. The axis 114 may illustrate, for example, the axes perpendicular to which the study images are taken, and the location indicator 116 can identify the point along each axis at which the displayed two-dimensional image of the structure was taken. Movement through the studies 108, 110, 112 can be controlled using a plurality of functionality icons 104 associated with the selected content 98. For example, the functionality icons 104 can be used to play, stop, and/or pause movement through the studies 108, 110, 112 simultaneously. Alternatively, the studies 108, 110, 112 can be selected, played, stopped, paused, and/or otherwise manipulated individually by selecting or otherwise activating the functionality icons 104. The icons 104 can also be used to import and/or otherwise display one or more new studies.

The exemplary workflow management system 10 described above can be useful in operating rooms or other healthcare environments that are crowded with a multitude of medical devices and other surgical equipment. The workflow management system 10 can be used by a healthcare professional to streamline the workflow related to the surgery or medical procedure to be performed, thereby increasing the professional's efficiency during the surgery. For example, the administrative staff can manage, among other things, the collection of content, and the selection and organization of key inputs once the physician's preferences are known. Thus, during the collection and organization phases, the management of this large volume of content can be taken out of the physician's hands, thereby freeing him/her to focus on patient care.

The pre-surgery organization of content can also assist in streamlining hospital workflow by reducing the time it takes to locate pertinent content for display during surgery. By collecting and organizing this content prior to surgery, precious time in the operating room can be saved. The workflow management system 10 also integrates content received from multiple heterogeneous historical and substantially real-time data sources. All of the collected and organized content can be quickly retrieved in the operating room during surgery. Current systems are not capable of such a high level of data integration.

Moreover, the exemplary workflow management system 10 discussed above is fully customizable with specialty-specific, content-specific, physician-specific and/or surgery-specific functionality. The system 10 can be programmed, prior to surgery, to perform functions and/or display content in ways useful to the specific type of surgery being performed. Prior systems, on the other hand, require multiple display devices to perform such specialty-specific and/or activity-specific functions, thereby crowding an already overcrowded operating room.

Other embodiments of the disclosed workflow management system 10 will be apparent to those skilled in the art from consideration of this specification. It is intended that the specification and examples be considered as exemplary only, with the true scope of the invention being indicated by the following claims.

### PARTS LIST

10—workflow management system
12—controller
14—storage device
16—content collection device
18—operator interface
22—remote receiver/sender
24—display device
28—connection line
30—Step: determined desired content
32—Step: construct initial checklist
34—Step: request content from heterogeneous sources
36—Step: perform test/capture content from heterogeneous sources
38—Step: collect/receive all content
40—Step: check in content
42—Step: verify checklist is complete
44—Step: is new content required?
46—Step: update checklist
48—Step: save
50—Step: go to organized phase
52—Step: select key inputs from all content received
54—Step: automatically associate content-specific functionality, unique to each content source/type, with each selected input
56—Step: assign each selected input to at least one phase or a surgical sequence
58—Step: assign each selected input to a priority level within the surgical sequence
60—Step: associate each selected input with a desired display location on a display device
62—Step: associate specialty-specific, physician-specific, and/or surgery-specific functionality with each selected input
64—Step: is there another phase in the surgical sequence?
66—Step: is collaboration required?
68—Step: prepare content/inputs for collaboration
70—Step: add collaboration indicator to display protocol
72—Step: save as a display protocol
74—Step: go to display phase
76—Step: retrieve saved display protocol
78—Step: display initial set of primary priority level inputs
80—Step: replace at least one primary priority level input with a secondary or tertiary priority level input
82—Step: display phases of surgical sequence and status indicator
84—Step: display universal functionality
86—Step: display content-specific, specialty-specific, physician-specific, and/or surgery-specific functionality with each activated primary priority level input
88—Step: display content captured/collected during surgical procedure
90—Step: setup
91—Step: use phase
92—Step: initialize collaboration
93—Step: activate universal functionality
94—surgical sequence phase indicator
95—Step: start collaboration with a remote user
96—universal functionality icon
98—content
100—functionality icon
101—functionality icon
102—content
103—diagnostic monitor icon
104—functionality icon
106—image
108—study
110—study
112—study
114—axis
116—location indicator

1. A method of workflow management, comprising:
collecting heterogeneous content associated with a surgical procedure from a plurality of heterogeneous content sources;
selecting a plurality of inputs from the heterogeneous content;
assigning each input of the plurality of inputs to at least one phase of a desired surgical sequence;
displaying a subset of the inputs assigned to a first phase of the surgical sequence; and
selecting one of the displayed inputs, wherein selecting one of the displayed inputs enables content-specific functionality associated with the selected one of the displayed inputs.

2. The method of claim 1, wherein selecting one of the displayed inputs causes the content-specific functionality associated with the selected one of the displayed inputs to be displayed.

3. The method of claim 1, wherein the content-specific functionality comprises at least one of specialty-specific functionality, doctor-specific functionality, and surgery-specific functionality.

4. The method of claim 1, wherein the desired surgical sequence comprises an accessing phase, an operative phase, an evaluation phase, and a withdrawal phase.

5. The method of claim 1, wherein the desired surgical sequence comprises a timeline of surgical tasks.

6. The method of claim 1, further comprising saving a display protocol comprising the collected heterogeneous content and the content-specific functionality in a stand-alone storage device.

7. The method of claim 1, further comprising displaying a subset of the inputs assigned to a second phase of the surgical sequence, the second phase being later in time than the first phase.

8. The method of claim 1, further comprising displaying a substantially real-time input collected during the surgical procedure.

9. The method of claim 8, wherein the substantially real-time input comprises a collaboration input.

10. The method of claim 1, wherein the heterogeneous content is collected according to a customized content checklist.

11. A method of workflow management, comprising:
receiving content associated with a surgical procedure from a plurality of heterogeneous sources;
selecting a plurality of inputs from the received content;
associating content-specific functionality with each of the plurality of selected inputs;
assigning each of the plurality of selected inputs to a phase of a desired surgical sequence;
assigning each of the plurality of selected inputs to one of a primary priority level, a secondary priority level, and a tertiary priority level;
displaying a plurality of primary priority level inputs associated with a first phase of the surgical sequence; and
selecting one of the displayed inputs, wherein selecting one of the displayed inputs causes content-specific functionality associated with the selected one of the displayed inputs to be displayed.

12. The method of claim 11, further comprising displaying a plurality of primary priority level inputs associated with a second phase of the surgical sequence while at least one of the inputs associated with the first phase of the surgical sequence is being displayed.

13. The method of claim 12, wherein the second phase of the surgical sequence is later in time than the first phase of the surgical sequence.

14. The method of claim 11, further comprising replacing a displayed primary priority level input with one of a secondary priority level input and a tertiary priority level input.

15. The method of claim 11, wherein the primary, secondary, and tertiary priority levels are organized based upon a known set of physician preferences.

16. The method of claim 11, wherein the tertiary priority level comprises heterogeneous content associated with the selected inputs of at least one of the primary and secondary priority levels.

17. A workflow management method, comprising:
receiving content associated with a surgical procedure;
selecting a plurality of inputs from the content based on a known set of physician preferences;
assigning each input of the plurality of inputs to a phase of a desired surgical sequence;
assigning each input of the plurality of inputs to one of a plurality of priority levels based on the known set of physician preferences;
displaying the inputs assigned to a first priority level of the plurality of priority levels;
displaying universal functionality associated with each of the displayed inputs; and
selecting one of the displayed inputs, wherein selecting one of the displayed inputs enables additional functionality associated with the selected input.

18. The method of claim 17, wherein the additional functionality comprises content-specific functionality associated with the selected input.

19. The method of claim 18, wherein the content-specific functionality comprises at least one of specialty-specific, doctor-specific, and surgery-specific functionality.

20. The method of claim 17, further comprising activating at least one of the additional functionality the selected image.

21. The method of claim 17, further comprising displaying a substantially real-time input captured during the surgical procedure.

22. The method of claim 17, further comprising displaying a map representative of the desired surgical sequence and a status identifier representative of an active phase of the surgical sequence.

23. The method of claim 17, further comprising preparing a displayed input for collaboration with a remote specialist.

24. The method of claim 17, further comprising selecting a different one of the displayed inputs, wherein selecting the different one of the displayed inputs enables additional functionality associated with the different one of the displayed inputs.

25. A modular healthcare workflow management system, the system comprising at least one of:
a collection component configured to request and receive healthcare content in accordance with a predefined checklist;
an organization component configured to select a plurality of inputs from the content, assign each input of the plurality of inputs to at least one phase of a surgical sequence, and assign each input of the plurality of selected inputs to a priority level within the surgical sequence; and
a display component configured to display an initial set of primary priority level inputs, wherein selecting a displayed primary priority level input causes at least one content-specific functionality icon to be displayed.
